(19) United States
(12) Patent Application Publication
(10) Pub. No.: US 2010/0002027 A1
(43) Pub. Date: Jan. 7, 2010

(54) DISPLAY DEVICE AND METHOD

(75) Inventors: Marcellinus Petrus Carolus Michael Krijn, Eindhoven (NL); Fetze Pijlman, Eindhoven (NL); Martin Jacobus Johan Jak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/526,092

(22) PCT Filed: Feb. 12, 2008
(86) PCT No.: PCT/IB2008/050502

§ 371 Date: Aug. 6, 2009

(30) Foreign Application Priority Data
Feb. 13, 2007 (EP) 07102201.6

(51) Int. Cl. G09G 5/02

(52) U.S. Cl. 345/694

(57) ABSTRACT

A display device (1) comprising an illuminating member (3) having a plurality of individually controllable light-emitting elements (5), a display panel (2) arranged to be illuminated by the illuminating member (3), the display panel comprising a plurality of individually controllable pixels (4a-d), and a display controller (6) adapted to receive image data (ID) indicative of a color image to be displayed by the display device (1). The display controller (6) is further adapted to individually control a color output of each light-emitting element (5) based on the received image data (ID). The performance of a display device having a controllable illuminating member, such as a backlight or a frontlight, can be considerably improved by individually controlling the color output, rather than merely the intensity, of the light-emitting members comprised in the controllable illuminating member.

### TECHNICAL FIELD OF THE INVENTION

The present invention relates to a display device comprising an illuminating member having a plurality of individually controllable light-emitting elements and a display panel arranged to be illuminated by the illuminating member, the display panel comprising a plurality of individually controllable pixels.

The invention further relates to a method for controlling such a display device and a computer program module.

### TECHNICAL BACKGROUND

Today, various types of flat-panel displays are used in a wide variety of applications, from mobile phone displays to large screen television sets. While some kinds of flat panel displays, such as so-called plasma displays, are comprised of arrays of light emitting pixels, the majority of flat-panel displays have arrays of pixels which can be switched between states but are unable to independently emit light. Such flat-panel displays include the ubiquitously found LCD-displays. In order for such flat-panel displays to be able to display an image to a user, the pixel array must be illuminated by either a so-called backlight, in the case of a transmissive type pixel array, or, in the case of a reflective type pixel array, by ambient light or a so-called frontlight.

A conventional backlight is comprised of a planar light-guide into which light is coupled from a light-source. One face of the planar light-guide is typically modified through structuring or modification, for example, surface roughening, to enable outcoupling of light through that face. The outcoupled light then passes through pixels in the pixel array, which are in a transmissive state, and a corresponding image becomes visible to a viewer.

When, however, as is often the case, only a very small proportion of the pixels are bright (in their transmissive state), a correspondingly large fraction of the light emitted by the backlight is prevented from reaching the viewer and precious energy is thus wasted.

By providing the backlight as a backlight panel having a plurality of individually controllable light-sources, on the other hand, the backlight can be locally dimmed, which results both in an enhancement of image contrast and in a reduction of power consumption.

WO 03077013 discloses a display device with such a backlight panel having a plurality of individually controllable light-sources, in which local dimming is implemented such that the gray scale values of the display panel pixels addressed by a certain controllable light-source in the backlight are scaled proportionally such that a larger portion of the dynamic range of the panel pixels is utilized. Subsequently, the controllable light-source in the backlight is dimmed accordingly, such that the output of the display device remains unchanged. Hereby, the power consumption is reduced and the dynamic range of the display device is increased.

There is, however, room for further improvement of the performance of a display device having a backlight comprising a plurality of individually controllable light-sources.

### SUMMARY OF THE INVENTION

In view of the above-mentioned and other drawbacks of the prior art, a general object of the present invention is to provide an improved display device, in particular enabling a lower power consumption and/or higher image contrast.

According to a first aspect of the present invention, these and other objects are achieved through a display device comprising an illuminating member having a plurality of individually controllable light-emitting elements, a display panel arranged to be illuminated by the illuminating member, the display panel comprising a plurality of individually controllable pixels, and a display controller adapted to receive image data indicative of a color image to be displayed by the display device, wherein the display controller is further adapted to individually control a color output of each light-emitting element based on the received image data.

The present invention is based upon the realization that a performance of a display device having a controllable illuminating member, such as a backlight or a frontlight, can be considerably improved by individually controlling the color output, rather than merely the intensity, of the light-emitting members comprised in the controllable illuminating member.

When, as is the case in the prior art, one is limited to adjusting the, typically white light, intensity of a light-emitting element, the intensity reduction is limited by the maximum color component value in the image data intended for the pixels illuminated by that particular light-emitting element. If, for an exemplary 8-bit display panel, one of the display pixels illuminated by the light-emitting element is allocated the color setting R (red)=50, G (green)=50, and B (blue)=255, then no reduction in the intensity of the light-emitting element is possible, since the exemplary pixel would then be saturated and the color output of the display panel would deteriorate. Consequently, in the prior art display device, no reduction in power consumption is achievable for the exemplary light-emitting element.

Considering the same exemplary color setting, the display device according to the present invention enables an individual reduction in intensity for each color primary. Consequently, although the amount of blue light cannot, according to the present example, be reduced, the amounts of red and green may, depending on the color settings of the other display panel pixels illuminated by the particular light-emitting element, be reduced without a resulting deterioration of the display device image output. If the maximum color settings for the color primaries turn out to be, say, Rₘₐₓ=100, Gₘₐₓ=150, and Bₘₐₓ=255, then the power consumption of the light-emitting element can, in the display device according to the present invention, be reduced by approximately 34%, which is a considerable improvement as compared to the prior art.

Furthermore, the individual control, according to the present invention, of the color output of each light-emitting element enables image enhancement through a temporary and local increase in the brightness and/or the color saturation. This is known as “peaking”, in the context of CRT-displays.

Advantageously, furthermore, each of the pixels may comprise a plurality of individually controllable sub-pixels each being adapted to allow passage of a respective different color component, and the display controller may be adapted to control the color output from each of the light-emitting elements and/or the light-transmission of each of the sub-pixels to compensate for color imbalance caused by leakage of light of a first color through such sub-pixels being adapted to allow passage of light of a second color.

In differently colored sub-pixels, color filters having light-transmission (or reflection) properties corresponding to the respective desired colors are typically included. This is, however, by no means necessary as the color of a certain sub-pixel may be realized by other components. For example, in the case of electrophoretic displays, the color of a certain pixel/sub-pixel may be determined by a color of displaced charged particles.

Due to leakage of light of a first color component through a sub-pixel designed and intended to allow passage of a second color component only, it is typically not sufficient to simply scale the color co-ordinates of the light-emitting element with respect to corresponding scaled sub-pixel color settings, since this would then lead to an unintended and potentially very annoying color imbalance of the display output.

This color imbalance may, for example, be compensated for by determining the color output from a light-emitting element and/or the light-transmission of each of the sub-pixels illuminated by that light-emitting element based on known leakage factors of these differently colored sub-pixels (in case of sub-pixels including color filters, these leakage factors are determined by the color filters.)

When such compensation for color imbalance due to leakage of light is implemented, the conversion matrix for conversion between modified and unmodified display pixel values typically contains off-diagonal terms, which is not the case for the above-mentioned simple scaling.

Moreover, the display controller may further be configured to control the color output from each of the light-emitting elements and/or the light-transmission of each of the sub-pixels to compensate for color imbalance caused by simultaneous illumination of the sub-pixels by more than one light-emitting element.

Depending on the actual arrangement of the illuminating member in relation to the display panel, pixels may be illuminated by light from more than one light-emitting element. Such compound illumination may lead to color imbalance and accompanying image artifacts in, the frequently occurring, cases when neighboring light-emitting elements are controlled to emit light having different colors and/or intensities.

This color imbalance may be compensated for by taking contributions from a number of adjacently located light-emitting elements into account when determining the respective light-transmissions of the sub-pixels illuminated by these light-emitting elements.

The display controller may, moreover, be configured to control a light-transmission of each of the display panel pixels such that an output from the display essentially corresponds to the received image data.

As touched upon above in connection with the so-called “peaking”, there may be some applications or modes of operation in which modifications in the display output are desired such that the display output at times does not directly correspond to the received image data. Generally, however, the output from the display should match the received image data. There may, of course, be some deviations due to such factors as the inherent display characteristics or, a certain amount of “clipping” (saturation of pixels) especially for energy saving settings.

Additionally, each light-emitting element may advantageously be configured to illuminate a plurality of pixels.

In practice, the resolution ratio between the illuminating member and the display panel is a design trade-off with respect to multiple parameters, such as, for example, cost, complexity, illumination member uniformity, yield, and power reduction capability. Obviously, the higher the resolution of the backlight is, the lower power consumption is achievable, since the illumination member (such as a backlight) could then be controlled to optimize its color output based on fewer display pixels. For a higher resolution, however, cost and complexity of control increases and the issue of production yield becomes more important.

According to one embodiment of the display device according to the present invention, each of the light-emitting elements may comprise a plurality of differently colored and individually controllable sub-elements, and the display controller may be adapted to, for each light-emitting element, evaluate the received image data to determine a maximum input sub-pixel value within each set of differently colored sub-pixels arranged to be illuminated by the light-emitting element, substitute the determined maximum input sub-pixel values with a maximum modified sub-pixel value for each of the sets of sub-pixels, and determine dimming factors for each of the sub-elements, such that the maximum modified sub-pixel values in combination with dimmed sub-elements result in essentially the same display output as the maximum input sub-pixel values in combination with un-dimmed sub-elements.

Hereby, the differently colored sub-elements comprised in each light-emitting element of the illuminating member can be individually dimmed while still achieving a display device output which corresponds to the received image data. This leads to a considerable reduction in power consumption as well as an enhanced contrast of the display device.

According to another embodiment of the display device according to the present invention, the display controller may be adapted to, for each light-emitting element, determine for the received image data a maximum brightness and a maximum degree of saturation per color for a plurality of pixels illuminated by the light-emitting element, and control a color of the light-emitting element and/or a light-transmission of each of a plurality of differently colored sub-pixels illuminated by the light-emitting element such that an addressable color space for the display device is reduced to a space defined by the determined maximum brightnesses and degrees of saturation.

Also in this embodiment of the present invention, the power consumption can be decreased and the contrast enhanced of the display device.

According to yet another embodiment of the display device of the present invention, the display controller may be configured to control a pixel and/or a light-emitting element illuminating the pixel such that a brightness and/or a color saturation of the pixel is temporarily enhanced beyond the received image data.

Hereby, the above-mentioned “peaking” can be realized in order to enhance the viewing experience of a user. At times when, and in respect of light-emitting elements for which, peaking is implemented, this is typically at the expense of the reduction in power consumption and enhanced contrast.

When implementing this so-called peaking, each of the light-emitting elements may advantageously comprise a plurality of differently colored and individually controllable sub-elements, and an average duty cycle of each of the sub-elements may be maintained below nominal 100%.

As such sub-elements, LEDs (light-emitting diodes) are especially suitable, since LEDs can typically handle being temporarily driven at a higher power than the nominal maximum, given that a duty cycle of the LED is kept within a specified range.

According to a second aspect of the present invention, the above-mentioned and other objects are achieved through a method for controlling a display device comprising an illuminating member having a plurality of individually controllable light-emitting elements and a display panel arranged to be illuminated by the illuminating member, the display panel comprising a plurality of individually controllable pixels, wherein the method comprises the steps of receiving image data indicative of a color image to be displayed by the display device, and controlling a color output of each light-emitting element individually based on the received image data, thereby enabling improved performance of the display device.

Effects and features of the present second aspect of the present invention are largely analogous to those described above in connection with the first embodiment.

According to a third aspect of the present invention, the above-mentioned and other objects are achieved through a computer program module adapted to perform the steps of the method according to the invention when run on a display controller comprised in a display device according to the invention.

Effects and features of the present third aspect of the present invention are largely analogous to those described above in connection with the first embodiment.

### BRIEF DESCRIPTION OF THE DRAWINGS

These and other aspects of the present invention will now be described in more detail, with reference to the appended drawings showing a currently preferred embodiment of the invention, wherein:

FIG. 1 is a schematic block diagram of the display device according to an embodiment of the present invention;

FIG. 2a is a schematic plane view of a portion of the display panel in FIG. 1;

FIG. 2b is a schematic plane view of a portion of the illuminating member in FIG. 1;

FIG. 3 schematically illustrates leakage through color filters in the sub-pixels of the display panel in FIG. 1 when illuminated by a sub-element comprised in a light-emitting element of the illuminating member.

FIG. 4 is a flow chart illustrating an embodiment of the method according to the present invention;

FIG. 5 schematically illustrates a cloud of pixel values in color space for an exemplary color image and the color points accessible to the display device with the illuminating member un-dimmed;

FIG. 6 schematically illustrates the accessible color points before and after dimming according to a first embodiment of the invention in a section plane parallel to the R- and G-axes in color space;

FIG. 7 schematically illustrates the accessible color points before and after dimming according to a second embodiment of the invention in a section plane parallel to the R- and G-axes in color space; and

FIG. 8 schematically illustrates illumination of a certain pixel by multiple light-emitting elements in the light-emitting member.

### DETAILED DESCRIPTION OF A PREFERRED EMBODIMENT OF THE INVENTION

In the following description, the present invention is described with reference to a simplified display device comprising a transmissive LCD-display panel in which each pixel includes three sub-pixels with color filters for allowing passage of red (R), green (G), and blue (B) light respectively, and a segmented LED-backlight in which each light-emitting element includes four differently colored LEDs (red (R), amber (A), green (G), and blue (B)).

It should be noted that this by no means limits the scope of the invention, which is equally applicable to display devices comprising another kind of display panel and/or another kind of illuminating member. For example, in the segmented LED-backlight, each light-emitting element may include three differently colored LEDs (red (R), green (G), and blue (B)), and in the transmissive LCD-display panel each pixel may include four sub-pixels with color filters for allowing passage of red (R), green (G), blue (B), and white (W) light, respectively. Moreover, the display panel may utilize another image forming technology, such as electrowetting, electrophoresis, magnetophoresis, electrochromicity, or micro-mechanical reflectors. Furthermore, the illuminating member may be realized by means of a matrix of other light-sources than LEDs, such as fluorescent lamps, or as a light-modifying member together with one or several light-sources, wherein the light-modifying member is adapted to enable modification of the color of the light emitted by the light-source(s).

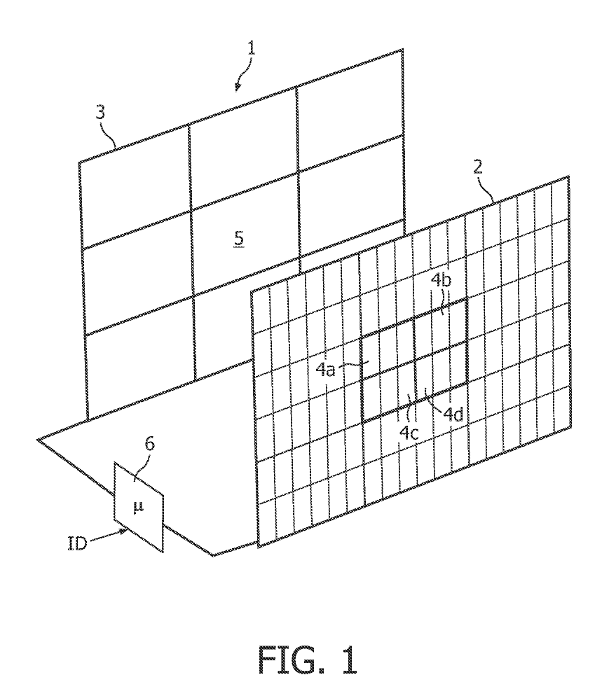

FIG. 1 schematically illustrates a display device 1 according to an embodiment of the present invention, in which a display panel in the form of a transmissive LCD-panel 2 is arranged to be illuminated by an illuminating member in the form of a segmented LED-backlight 3. The LCD-panel 2 comprises a plurality of individually controllable pixels 4a-d, only four of which are indicated here for the sake of clarity of drawing, and the backlight 3 comprises a plurality of individually controllable light-emitting elements 5, only the one arranged to illuminate the indicated pixels 4a-d being indicated by a reference numeral for the sake of clarity of drawing.

The display device 1 further includes a display controller 6 which is configured to receive image data ID indicative of a color image to be displayed by the display device 1, and to individually control the light-transmission (intensity and color) of each of the pixels 4a-d comprised in the display panel 2 and the color output (intensity and color) of each of the light-emitting elements 5 comprised in the backlight 3.

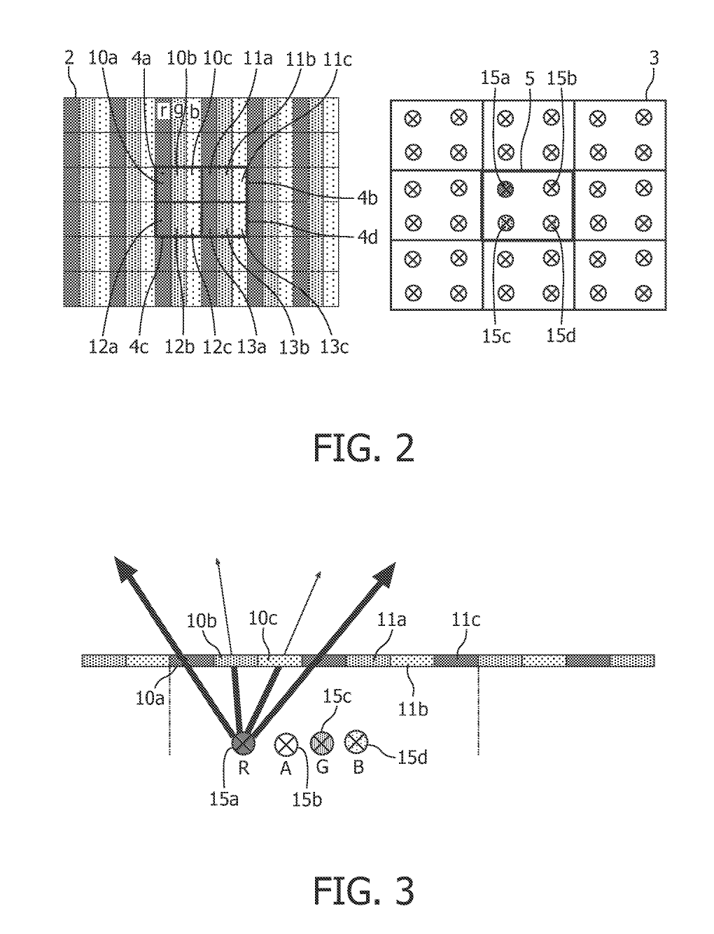

In FIGS. 2a-b, portions of the LCD-panel 2 and the backlight 3, respectively, from FIG. 1 are schematically shown.

Referring first to FIG. 2a, each of the pixels 4a-d of the LCD-panel 2 is sub-divided into three differently colored and individually controllable sub-pixels 10a-c-13a-c. Each pixel 4a-d includes a red (R) 10a-13a, a green (G) 10b-13b, and a blue (B) 10c-13c sub-pixel which each, assuming an 8-bit dynamic range per color for the display panel 2, can be controlled to pixel values P_{R}, P_{G}, P_{B} between 0 and 255, where 0 corresponds to minimum transmission of light and 255 corresponds to maximum transmission of light of the respective colors.

Turning now to FIG. 2b, a portion of the illuminating member 3 is shown, in which the light-emitting element 5 is arranged to illuminate the pixels 4a-d. The light-emitting element 5 includes four differently colored sub-elements 15a-d, which are each configured to controllably emit light having different respective colors. In the present example, the sub-element 15a is controllable to emit red (R) light at an intensity L_{R} between 0 and 255 and the remaining sub-elements 15b-d are similarly controllable to emit amber (A), green (G), and blue (B) light, respectively, at intensities L_{A}, L_{G}, L_{B} between 0 and 255.

A typical situation with imperfect color filters in the sub-pixels 10-13a-c will now be described with reference to FIG. 3. In FIG. 3, a schematic cross-section view of the display device in FIG. 1 is shown in which the sub-pixels 10-13a-c (only 10-11a-c are visible in the cross-section view of FIG. 3) are illuminated by the light-emitting element 5 having sub-elements 15a-d.

As is illustrated for the exemplary situation where all the sub-pixels 10-11a-c are set to transmit fully and only the red (R) sub-element 15a is set to emit light, the light emitted by the red sub-element 15a is not only allowed to pass through the “red” sub-pixels 10-11a, but some red light also leaks through other, differently colored, sub-pixels, as indicated by the thin arrows passing through the green and blue sub-pixels 10b-c.

The magnitude of this leakage is, in the case of color filters being used to achieve differently colored sub-pixels, a material property of the particular color filter used, and, in the case of a backlight emitting white light, the display device can be initially calibrated to take this leakage into account. If, however, the color of the light emitted by the backlight, or by parts of the backlight, would be changed from its initial color, the above-described leakage would lead to a color shift or imbalance in the image which would potentially be very annoying to the viewer.

This is especially the case for multiple sub-pixels such as RGBW (W=white): the white sub-pixels (that is, no color filter) will transmit the light of all the sub-elements or light sources illuminating it. The same holds when multiple primary light sources are used, such as RAGB (A=amber): the amber source will be transmitted by red as well as green color filters.

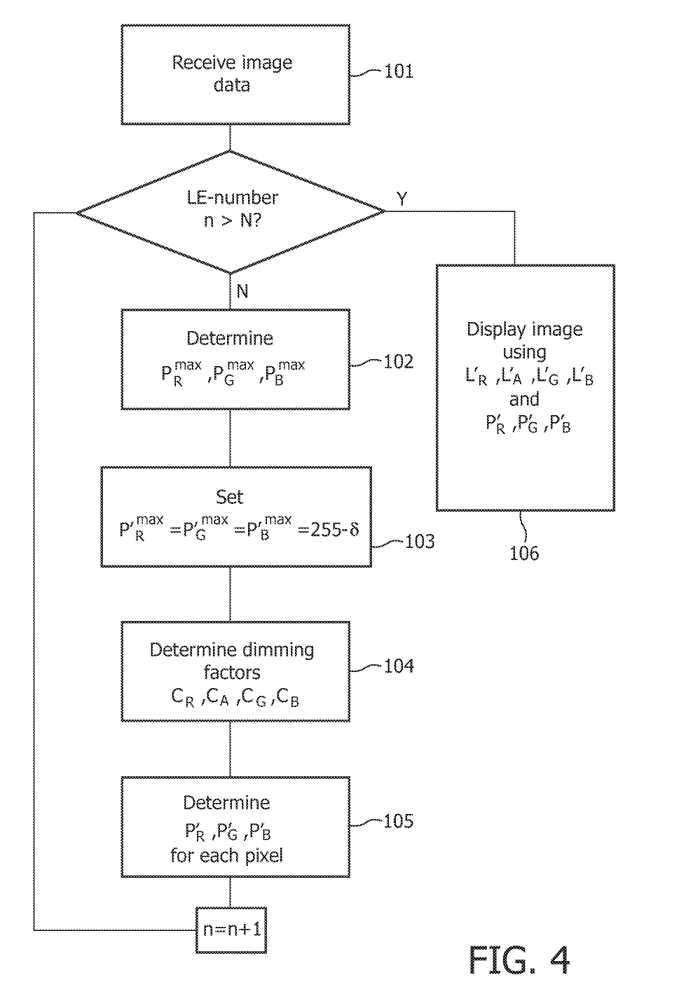

With reference to the flow chart in FIG. 4 and the above referenced FIGS. 1-3, a preferred embodiment of the method according to the invention will now be described, according to which the problem of color imbalance due to color leakage in the sub-pixels 10-13a-c of the display panel 2 is addressed.

In the following description, it is assumed that the light-emitting elements 5 of the illuminating member 3 do not overlap, that is, that each pixel 4a-d of the display panel 2 can be allotted to a particular light-emitting element 5 in a unique and unambiguous way. Modifications for handling cases with overlap between neighboring light-emitting elements will be described below in connection with FIG. 8.

Consider a certain light-emitting element 5 and a display panel pixel 4a illuminated by this light-emitting element 5. The tristimulus value, or color co-ordinates [X Y, Z] of this pixel 4a as experienced by the viewer, is given by the relation:

$$[ \begin{matrix}X \\ Y \\ Z\end{matrix} ] = M \cdot [ \begin{matrix}{P}_{R} \\ {P}_{G} \\ {P}_{B}\end{matrix} ] \qquad ( 1 )$$

Note that the tristimulus value [X Y,Z] includes color as well as intensity. In this relation, [P_{R}, P_{G}, P_{B}] are the gray-scale values of the RGB sub-pixels 10a-c as offered to the display panel and corresponding to the received image data ID. A proportionality matrix M can be formed, which takes into account the spectral composition and the intensity of the differently colored sub-elements 15a-d as well as the transmission characteristics of the color filters in the sub-pixels 10a-c. This matrix is defined as follows:

$$M = [ \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ] \qquad ( 2 )$$

The elements of this matrix are in turn defined by the following relation (considering, for example, the red color filters in the sub-pixels 10-13a):

$$\vec{R} = [ \begin{matrix}{X}_{R} \\ {Y}_{R} \\ {Z}_{R}\end{matrix} ] = {M}_{R} \cdot [ \begin{matrix}{L}_{R} \\ {L}_{A} \\ {L}_{G} \\ {L}_{B}\end{matrix} ] \qquad ( 3 )$$

\vec{R}=[X_{R}, Y_{R}, Z_{R}] denotes the tristimulus value of light transmitted by a red sub-pixel 10-13a when in its on-state. This value depends on the strengths of the red 15a, amber 15b, green 15c, and blue 15d sub-elements, [L_{R}, L_{A}, L_{G}, L_{B}] corresponding to the backlight pixel 4a-d under consideration. It also depends on the transmission matrix, M_{R}, describing the transmission of the light of these sub-elements 15a-d through the red color filters. This matrix is known in practice. In the presently described example, the case of four primary light sources is described. It should, however, be noted that the here described method is applicable to any number of primaries. Similar relations exist for the green and blue color filters.

After dimming the backlight pixel (controlling the color output of the particular light-emitting element 5), the tristimulus value of the light transmitted by a red sub-pixel, when in its on-state, is given by:

$$\begin{matrix}{\vec{R}}^{′} = [ \begin{matrix}{X}_{R}^{′} \\ {Y}_{R}^{′} \\ {Z}_{R}^{′}\end{matrix} ] = {M}_{R} \cdot [ \begin{matrix}{L}_{R}^{′} \\ {L}_{A}^{′} \\ {L}_{G}^{′} \\ {L}_{B}^{′}\end{matrix} ] , \\ with & ( 4 ) \\ [ \begin{matrix}{L}_{R}^{′} \\ {L}_{A}^{′} \\ {L}_{G}^{′} \\ {L}_{B}^{′}\end{matrix} ] = [ \begin{matrix}{c}_{R} & 0 & 0 & 0 \\ 0 & {c}_{A} & 0 & 0 \\ 0 & 0 & {c}_{G} & 0 \\ 0 & 0 & 0 & {c}_{B}\end{matrix} ] \cdot [ \begin{matrix}{L}_{R} \\ {L}_{A} \\ {L}_{G} \\ {L}_{B}\end{matrix} ] . & ( 5 )\end{matrix}$$

In this relation, [c_{R}, c_{A}, c_{G}, c_{B}] are the dimming factors of the RAGB light sources 15a-d. The transmission matrix M_{R}, of course, does not depend on the amount of dimming of the light-emitting element 5.

The relation between the old pixel values (that is, before dimming of the illuminating member 3) and the new ones (that is, after dimming of the illuminating member 3) is given by the relation:

$$[ \begin{matrix}{P}_{R}^{′} \\ {P}_{G}^{′} \\ {P}_{B}^{′}\end{matrix} ] = {[ \begin{matrix}{X}_{R}^{′} & {X}_{G}^{′} & {X}_{B}^{′} \\ {Y}_{R}^{′} & {Y}_{G}^{′} & {Y}_{B}^{′} \\ {Z}_{R}^{′} & {Z}_{G}^{′} & {Z}_{B}^{′}\end{matrix} ]}^{- 1} \cdot [ \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ] \cdot [ \begin{matrix}\begin{matrix}{P}_{R} \\ {P}_{G}\end{matrix} \\ {P}_{B}\end{matrix} ] \qquad ( 6 )$$

Turning again to FIG. 4, the display controller 6 receives image data ID indicative of an image to be displayed by the display device 1 in a first step 101. For each light-emitting member LEₙ in the backlight 3, steps 102 to 105 are then performed. In step 102, the maximum input sub-pixel values P_{R}^{max}, P_{G}^{max}, P_{B}^{max} in the image data ID among the sub-pixels 10a-c-13a-c illuminated by the particular light-emitting member 5 are determined.

[P_{R} P_{G} P_{B}]=[P_{R}^{max} P_{G}^{max} P_{B}^{max}]. (7)

In the subsequent step 103, the determined maximum input sub-pixel values P_{R}^{max}, P_{G}^{max}, P_{B}^{max} are substituted by maximum modified sub-pixel values P′_{R}^{max}, P′_{G}^{max}, P′_{B}^{max} desired following the adjustment of the display device 1, which in the present example are all set to the value of maximum transmission minus a margin to avoid clipping, in other words, the maximum sub-pixel values are set to P′_{R}^{max}=P′_{G}^{max}=P′_{B}^{max}=255−δ. Instead of having a fixed margin δ, one may adopt a heuristic approach and let the margin become dependent on the amount of dimming per color (for example, the largest margin for the color dimmed the most).

In the following step, 104, the dimming factors c_{R}, c_{A}, c_{G}, c_{B} are determined by substituting equation (7) into equation (6). In other words, we demand that the tristimulus values of the pixels as perceived by the viewer before and after dimming are equal.

After rewriting the resulting relation, one arrives at

$${A}_{1} \cdot [ \begin{matrix}\begin{matrix}\begin{matrix}{c}_{R} \\ {c}_{A}\end{matrix} \\ {c}_{G}\end{matrix} \\ {c}_{B}\end{matrix} ] = {A}_{2} \cdot [ \begin{matrix}\begin{matrix}{P}_{R}^{max} \\ {P}_{G}^{max}\end{matrix} \\ {P}_{B}^{max}\end{matrix} ] \qquad ( 8 )$$

From this relation, one can solve the dimming factors [c_{R}, c_{A}, c_{G}, c_{B}]. It should here be noted that the solution need not be unique. However, in the special case with as many different color filters as there are primary light sources the solution to equation (8) is unique.

Based on the dimming factors determined in step 104, the modified pixel values P_{R}′, P_{G}′, and P_{B}′ are determined for each pixel 4a-d illuminated by the particular light-emitting element 5 in step 105 using the relation given by equation 6.

After having performed the steps 102-105 for each light-emitting element in the illuminating member 3, the display device 1 is controlled by the display controller 6 to display an image using the here determined backlight 3 sub-element 15a-d intensities L_{R}′, L_{A}′, L_{G}′, and L_{B}′, and the modified pixel values P_{R}′, P_{G}′, and P_{B}′, in step 106.

It should here also be noted that the above-mentioned “peaking”, for example, can be achieved by multiplying the thus obtained dimming factors [c_{R}, c_{A}, c_{G}, c_{B}] by some factor greater than one.

Going into further detail, we will now consider the case with only two different color filters, red and green, and only two primary light-emitting sub-elements, red and green. In that case, equation (8) becomes:

$$\begin{matrix}[ \begin{matrix}{c}_{R} \\ {c}_{G}\end{matrix} ] = {A}_{1}^{- 1} \cdot {A}_{2} \cdot [ \begin{matrix}{P}_{R}^{max} \\ {P}_{G}^{max}\end{matrix} ] \\ with & & ( 9 ) \\ {A}_{1} = [ \begin{matrix}{m}_{R}^{11} {π}_{R} {L}_{R} + {m}_{G}^{11} {π}_{G} {L}_{R} & {m}_{R}^{12} {π}_{R} {L}_{G} + {m}_{G}^{12} {π}_{G} {L}_{G} \\ {m}_{R}^{21} {π}_{R} {L}_{R} + {m}_{G}^{21} {π}_{G} {L}_{R} & {m}_{R}^{22} {π}_{R} {L}_{G} + {m}_{G}^{22} {π}_{G} {L}_{G}\end{matrix} ] , \\ and & & ( 10 ) \\ {A}_{2} = [ \begin{matrix}{m}_{R}^{11} {L}_{R} + {m}_{R}^{12} {L}_{G} & {m}_{G}^{11} {L}_{R} + {m}_{G}^{12} {L}_{G} \\ {m}_{R}^{21} {L}_{R} + {m}_{R}^{22} {L}_{G} & {m}_{G}^{21} {L}_{R} + {m}_{G}^{22} {L}_{G}\end{matrix} ] . & & ( 11 )\end{matrix}$$

In equation (10), π_{R}=P′_{R}^{max} and π_{G}=P′_{G}^{max}. Note that the matrix A=A₁⁻¹·A₂ in equation (9) contains off-diagonal terms which are not present in case one uses a naïve dimming method in which leakage of color filters is not taken into account.

The above-described method will now be exemplified using an exemplary image to be displayed by the display device 1.

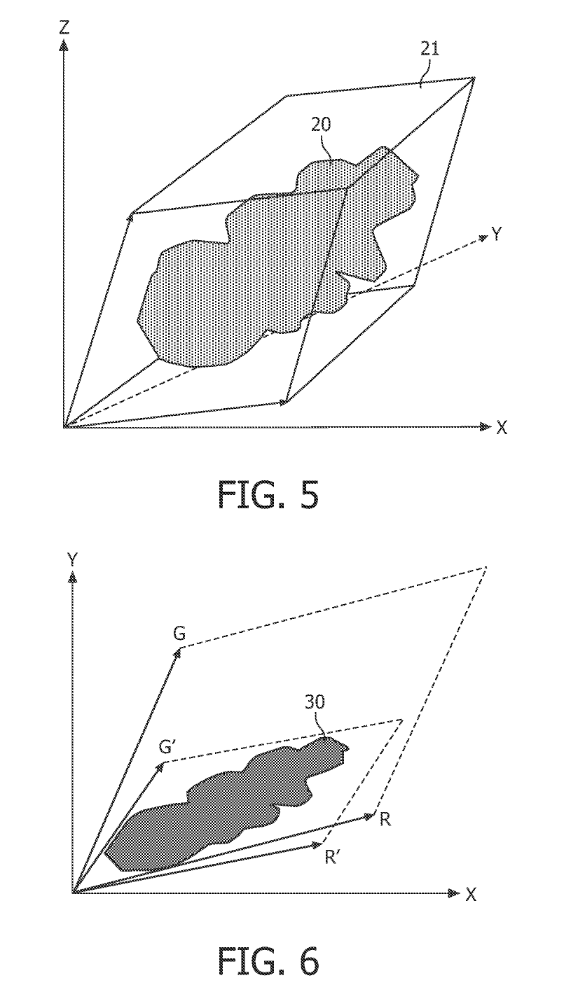

In FIG. 5, this image is represented by a cloud 20 of pixel values in color space representing the image. The box 21 in FIG. 5, which contains the cloud, represents the color points accessible to the display device with all of the light-emitting elements 5 in the backlight 3 undimmed, that is, the backlight emitting a uniform monochrome light at its maximum intensity.

In FIG. 5, the X-axis represents mainly the eye's sensitivity for red, Y represents green, and Z represents blue.

In order to simplify the following discussion, consider now a case with only two color filters (for example, red and green) per pixel and two primary light sources, or sub-elements, (for example, red and green) per light-emitting element. In this case, the color space in FIG. 5 is transformed to the section plane 30 in FIG. 6. Supposing now that the color filters leak as described above in connection with FIG. 3. For the situation sketched in FIG. 6, one can infer that it should be possible to slightly dim the red light source and to dim the green light source by a factor of two. However, when doing so, less green light will leak through the red color filters. As a result, the light transmitted by the red color filter will become more pure. Light transmitted by the green color filter, on the other hand, will become less pure.

In order not to detrimentally influence the perceived image quality, this leakage should thus be taken into account, which can be done, for example, using the method described above in connection with FIG. 4.

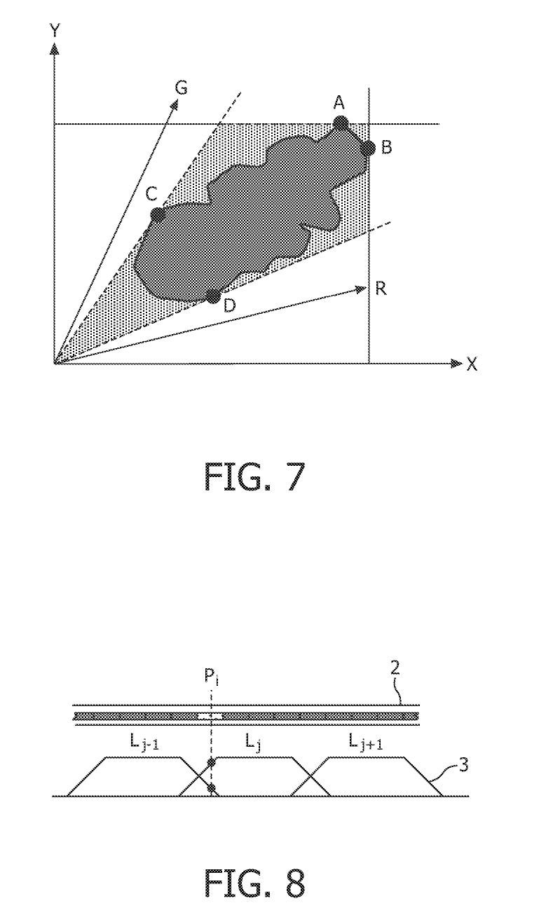

According to a second embodiment of the present invention, the modified settings for the light-emitting elements 5 comprised in the illuminating member 3 and the pixels 4a-d comprised in the display panel 2 may be determined as schematically illustrated in FIG. 7. According to this second embodiment, the maximum brightness per color (points A and B in FIG. 7) and for each color the maximum degree of saturation that needs to be achieved (points C and D) are determined for the pixels 4a-d illuminated by a certain backlight pixel 5. With this knowledge, the backlight and display are optimized, for instance, with respect to energy consumption, while making sure that the required color co-ordinates can still be addressed.

Finally, the situation where the emission patterns of neighboring light-emitting elements 5 overlap will be discussed with reference to FIG. 8.

In FIG. 8, a pixel Pᵢ in the display panel 2 is shown to be illuminated by adjacently located light-emitting elements Lⱼ₋₁, Lⱼ in the illuminating member 3. It will, in the following, be demonstrated how the method described in connection with FIG. 4 can be modified to compensate for such an overlap between neighboring light-emitting elements. The relations below hold under the following two assumptions:

1) The backlight 3 is designed such that one is able to uniformly illuminate the whole display panel 2 when all light-emitting elements 5 are at their nominal undimmed strength (This can, for example, be achieved through inserting a diffuser (not shown) between the backlight 3 and the display panel 2.); and
2) Given a light-emitting element 5, the emission patterns of the individual differently colored sub-elements 15a-d coincide.
Consider the monochrome case first. Let Lᵢⱼ be the luminance at the location of display pixel i resulting from backlight pixel j. Given the first assumption, it holds that

$${\sum }_{j} {L}_{ij} = c , \qquad ( 12 )$$

with c being a constant. Let Pᵢ be the grey scale value of display pixel i before dimming. We distribute this grey scale value among the backlight pixels illuminating this display pixel:

Pᵢⱼ=Pᵢ·Lᵢⱼ/c. (13)

In this expression, Pᵢⱼ is the fraction of the grey scale value of display pixel i allotted to backlight pixel j. With this partition,

$${P}_{i} = {\sum }_{j} {P}_{ij} . \qquad ( 14 )$$

Next, the steps described in connection with FIG. 4 are performed. The first step in this algorithm is to find the maximum gray scale value occurring in the collection of pixels i illuminated by backlight pixel j (i.e. the backlight pixel under consideration). In order to take into account that backlight pixel j has a non-uniform intensity distribution, we weigh Pᵢⱼ with a weight factor:

Pᵢⱼ→Pᵢⱼ·c/Lᵢⱼ=Pᵢ. (15)

In other words, we can take Pᵢⱼ=Pᵢ when searching for the maximum gray scale value occurring. As a result, after dimming, we obtain dimming factors for backlight pixel j and new gray scale values Pᵢⱼ′:

$${P}_{ij}^{′} = {P}_{ij} \cdot \frac{{L}_{ij}}{{L}_{ij}^{′}} \qquad ( 16 )$$

The primes denote the situation after dimming. In fact, Lᵢⱼ′/Lᵢⱼ is the dimming factor of backlight pixel j (in fact, independent of i). The actual gray-scale values to be displayed on the panel are re-obtained from the relation:

$${P}_{i}^{′} = {P}_{i} \cdot \frac{{\sum }_{j} {L}_{ij}}{{\sum }_{j} {L}_{ij}^{′}} . \qquad ( 17 )$$

The extension to color is now straightforward as long as the second assumption is obeyed: by construction, this procedure gives correct results for all color filters and primary light sources.

In practice, it may be advantageous to consider only those backlight pixels j contributing to a certain display pixel i for which the luminance exceeds a certain threshold value relative to the luminance value in the centre of the backlight pixels: this avoids taking into account any long tails of the luminance distribution of the backlight pixels, thereby reducing the computational effort.

The person skilled in the art realizes that the present invention by no means is limited to the preferred embodiments described above. For example, a diffuser or other optical element may be positioned between the illuminating member and the display panel in order to condition the light emitted by the light-emitting element in various possible ways. Furthermore, as an alternative to the embodiments described above, the display device according to the present invention may be based on so-called spectrum sequential illumination. For example, each pixel of the display panel may have two sub-pixels; one with color filter A and one with color filter B. The light-emitting elements in the illuminating member may each be equipped with light-sources C and D. In operation, each image frame is then divided into two sub-frames. In one sub-frame, source C is on whereas in the second sub-frame source D is on. Each of the color filters A and B transmits a part of the spectrum emitted by sources C and D. Additionally, the illuminating member may be scanned. For example, the backlight may be divided into a number of rows. In operation each row is activated in succession in synchronicity with addressing the rows of display panel pixels. This method is useful in decreasing the image blur resulting from display panel response time. This is especially the case for LCD displays.

1. A display device comprising:
an illuminating member (3) having a plurality of individually controllable light-emitting elements;
a display panel arranged to be illuminated by said illuminating member (3), said display panel comprising a plurality of individually controllable pixels, each of said pixels comprises a plurality of individually controllable sub-pixels, each being adapted to allow passage of a respective different color component; and
a display controller adapted to:
receive image data (ID) indicative of a color image to be displayed by the display device,
individually control a color output of each light-emitting element and/or said light-transmission of each of said sub-pixels based on said received image data (ID) in response to a leakage factor of light of a first color through sub-pixels being adapted to allow passage of light of a second color

2. (canceled)

3. A display device according to claim 1, wherein said display controller is further configured to control said color output from each of said light-emitting elements and/or said light-transmission of each of said sub-pixels in response to a color imbalance caused by simultaneous illumination of said sub-pixels by more than one light-emitting element.

4. A display device according to claim 1, wherein said display controller is further configured to control a light-transmission of each of said pixels such that an output from said display corresponds to said received image data (ID).

5. A display device according to claim 1, wherein each light-emitting element is configured to illuminate a plurality of pixels.

6. A display device according to claim 1, wherein:
each of said light-emitting elements comprises a plurality of differently colored and individually controllable sub-elements; and
said display controller is adapted to, for each light-emitting element:
evaluate said received image data (ID) to determine a maximum input sub-pixel value (P_{R}^{max}, P_{G}^{max}, P_{B}^{max}) within each set of differently colored sub-pixels arranged to be illuminated by said light-emitting element;
substitute said determined maximum input sub-pixel values (P_{R}^{max}, P_{G}^{max}, P_{B}^{max}) with a maximum modified sub-pixel value (P′_{R}^{max}, P′_{G}^{max}, P′_{B}^{max}) for each of said sets of sub-pixels; and
determine dimming factors (c_{R}, c_{A}, c_{G}, c_{B}) for each of said sub-elements (15a-d), such that said maximum modified sub-pixel values (P′_{R}^{max}, P′_{G}^{max}, P′_{B}^{max}) in combination with dimmed sub-elements result in essentially the same display output as said maximum input sub-pixel values (P_{R}^{max}, P_{G}^{max}, P_{B}^{max}) in combination with un-dimmed sub-elements (15a-d).

7. display device according to claim 1, wherein said display controller is adapted to, for each light-emitting element:
determine for said received image data (ID) a maximum brightness (A, B) and a maximum degree of saturation (C, D) per color for a plurality of pixels illuminated by said light-emitting element; and
control a color output of said light-emitting element and/or a light-transmission of each of a plurality of differently colored sub-pixels illuminated by said light-emitting element such that an addressable color space for said display device is reduced to a space defined by said determined maximum brightnesses (A, B) and degrees of saturation (C, D).

8. A display device according to claim 1, wherein said display controller is configured to:
control a pixel and/or a light-emitting element illuminating said pixel (4a-d) such that a brightness and/or color saturation of said pixel (4a-d) is temporarily enhanced beyond said received image data (ID).

9. A display device according to claim 8, wherein:
each of said light-emitting elements comprises a plurality of differently colored and individually controllable sub-elements; and
an average duty cycle of each of said sub-elements is maintained below nominal 100%.

10. A method for controlling a display device comprising:
an illuminating member (3) having a plurality of individually controllable light-emitting elements; and
a display panel arranged to be illuminated by said illuminating member (3), said display panel comprising a plurality of individually controllable pixels, each of said pixels comprises a plurality of individually controllable sub-pixels each being adapted to allow passage of a respective different color component; said method comprising the steps of:
receiving (101) image data (ID) indicative of a color image to be displayed by the display device;
controlling a color output of each light-emitting element individually based on said received image data (ID), thereby enabling improved performance of said display device; and
controlling said color output from each of said light-emitting elements and/or said light-transmission of each of said sub-pixels in response to a leakage factor of light of a first color through sub-pixels being adapted to allow passage of light of a second color.

11. (canceled)
